(19) United States
(12) Patent Application Publication
(10) Pub. No.: US 2011/0210703 A1
(43) Pub. Date: Sep. 1, 2011

(54) Thermal Sensor Device With Average Temperature And Hot Spot Feedback

(75) Inventors: Chad Souza, North Providence, RI (US); Curtis Martin, Westerly, RI (US)

(73) Assignee: Boston-Power, Inc., Westborough, MA (US)

(21) Appl. No.: 13/037,861

(22) Filed: Mar. 1, 2011

Related U.S. Application Data
(60) Provisional application No. 61/339,178, filed on Mar. 1, 2010.

(51) Int. Cl. H02J 7/00

(52) U.S. Cl. 320/136

(57) ABSTRACT

A battery system employs a plurality of PTC devices and an additional temperature sensor to provide safety and optimization features in a multi-cell battery system. The system provides both temperature fault detection and information that may be used for battery system performance optimization. A single negative temperature coefficient (NTC) thermistor and multiple PTC thermal protection devices are integrated into a battery block, and can be implemented as a single sensor package that is in thermal contact with each of the battery cells in the battery block.

### RELATED APPLICATION

This application claims the benefit of U.S. Provisional Application No. 61/339,178, filed on Mar. 1, 2010. The entire teachings of the above application are incorporated herein by reference.

### BACKGROUND

In multi-cell lithium ion battery systems, temperature must be monitored for both safety and performance optimization. Various techniques are typically employed for multi-cell battery temperature monitoring. A first technique implements a thermistor device to monitor the temperature of each cell of the battery. A second approach includes monitoring the temperature of a group of cells with a single thermistor device, thereby reducing system cost and complexity. A third approach includes monitoring each cell with a string of positive temperature coefficient (PTC) thermal protection devices.

### SUMMARY

Example embodiments of the present invention employ a plurality of PTC devices and an additional temperature sensor to provide safety and optimization features in a multi-cell battery system. The system provides both temperature fault detection and information that may be used for battery system performance optimization. A single negative temperature coefficient (NTC) thermistor and multiple PTC thermal protection devices may be integrated into a battery block, and may further be implemented as a single sensor package that is in thermal contact with each of the battery cells in the battery block.

Embodiments of the invention include a system for monitoring a multi-cell battery, which includes a plurality of positive-temperature coefficient (PTC) devices, each PTC devices configured to detect relative temperature at a respective one of a plurality of cells of a multi-cell battery. A thermal sensor is configured to measure an average temperature among the plurality of cells. Further, a control circuit configured to selectively enable and disable a cell of the plurality of cells based on outputs of the plurality of PTC devices and thermal sensor. The thermal sensor may include a negative-temperature coefficient (NTC) thermistor.

The control circuit may configured to selectively enable and disable a subset of the plurality of cells independent of a remainder of the plurality of cells, or may enable and disable the entire plurality of cells. In response to a detected fault at the thermal sensor or PTC devices, the control circuit may enable or disable the cells based on the device (PTC devices or thermal sensor) that is still operational. The control circuit may also control a cooling unit, such as a fan, to cool the plurality of cells.

In further embodiments, a thermal bus may be coupled to the thermal sensor, and may be incorporated into a printed circuit board (PCB), electrical power bus, or an enclosure supporting the plurality of cells. A monitor circuit may be configured to determine the temperature status of each of the plurality of cells based on a measured resistance across the plurality of PTC devices. The PTC devices may be connected in a series circuit configuration, where the plurality of PTC devices each include a PTC resistor and an identification resistor connected in parallel, and the identification resistor has a unique resistor value among each of the plurality of PTC devices.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a battery system in which embodiments of the present invention may be implemented.

FIGS. 2A-E are block diagrams of a battery block in various embodiments of the present invention.

FIG. 3 is a flow diagram of a method for monitoring and controlling a multi-cell battery.

FIG. 4A is a schematic diagram of a monitor for a NTC thermistor.

FIG. 4B is a schematic diagram of a monitor for a plurality of NTC thermistors.

FIG. 5A is a schematic diagram of a monitor for a PTC device.

FIG. 5B is a schematic diagram of a monitor for a plurality of PTC devices.

FIG. 6A is a schematic diagram of a battery block implementing a thermal conduction path.

FIG. 6B is a schematic diagram of a battery block implementing a thermal conduction path in a further embodiment.

FIG. 7A is a plot of resistance and temperature data of a thermal indicator installed on a thermal sensor printed circuit board in one embodiment.

FIG. 7B is a plot of negative thermal coefficient (NTC) resistance vs. temperature of a thermistor installed in a thermal printed circuit.

FIG. 7C is a plot of positive thermal coefficient (PTC) temperature vs. resistance installed in a thermal printed circuit board.

### DETAILED DESCRIPTION

It is desirable to avoid operation of most battery cells above 60° C. Operation at temperatures above 60° C. will severely limit the battery cell's cycle life. Also, lithium ion (LiIon) battery cells can go into a thermal runaway condition at elevated temperatures (typically >75° C.). Thermal runaway can introduce a safety hazard in multi-cell battery systems; therefore, it is important to be certain that all cells in the battery system are operating below 75° C. Although the thermistor device will provide a means of primary temperature fault detection it is also important to have a fail-safe means of secondary temperature fault detection as well in order to avoid thermal runaway.

Three techniques are typically employed for multi-cell battery temperature monitoring. A first technique implements a number of thermistor devices to monitor the temperature of each cell. This approach is most effective for providing the highest level of safety and performance optimization. However, implementing this technique is costly with regard to number of components and system complexity.

A second approach includes monitoring the temperature of a group of cells with a single thermistor device, thereby reducing system cost and complexity. Monitoring the temperature of a group of cells with a single device introduces the risk of masking an unsafe condition where one of the cells becomes significantly hotter than the others.

A third approach includes monitoring each cell with a string of positive temperature coefficient (PTC) thermal protection devices. An example of such PTC monitoring is described in U.S. Pat. No. 6,356,424. This technique is low-cost and provides adequate safety protection. However, PTC monitoring, by itself, does not accommodate performance optimization due to its nonlinear resistance vs. temperature characteristic and hysteresis effects.

Example embodiments of the present invention employ a plurality of PTC devices and an additional temperature sensor to provide safety and optimization features in a multi-cell battery system. The system provides both temperature fault detection and information that may be used for battery system performance optimization. A single negative temperature coefficient (NTC) thermistor and multiple PTC thermal protection devices may be integrated into a battery block, and may further be implemented as a single sensor package that is in thermal contact with each of the battery cells in the battery block.

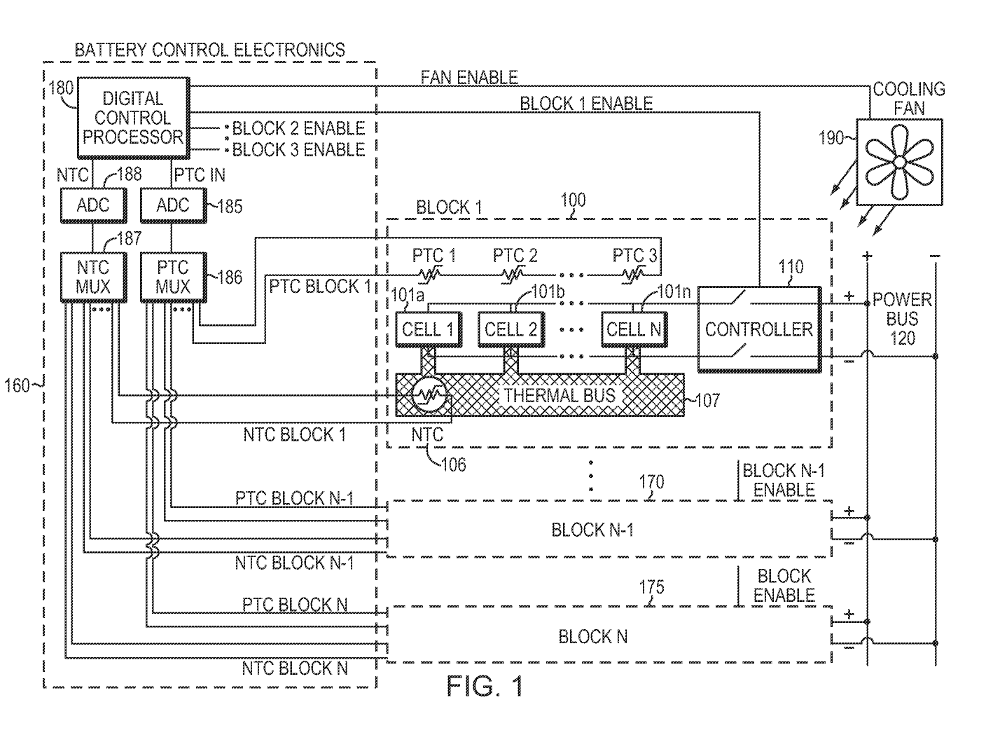

FIG. 1 is a block diagram of a battery system 150 in which embodiments of the present invention may be implemented. The battery system includes battery control electronics 160 and one or more battery blocks 100, 170, 175, the battery control electronics controlling charging and discharging of each of the battery blocks 100, 170, 175 to a power bus 120, as well as monitoring and controlling cells (e.g., battery cells 101a-n) within each battery block 100, 170, 175.

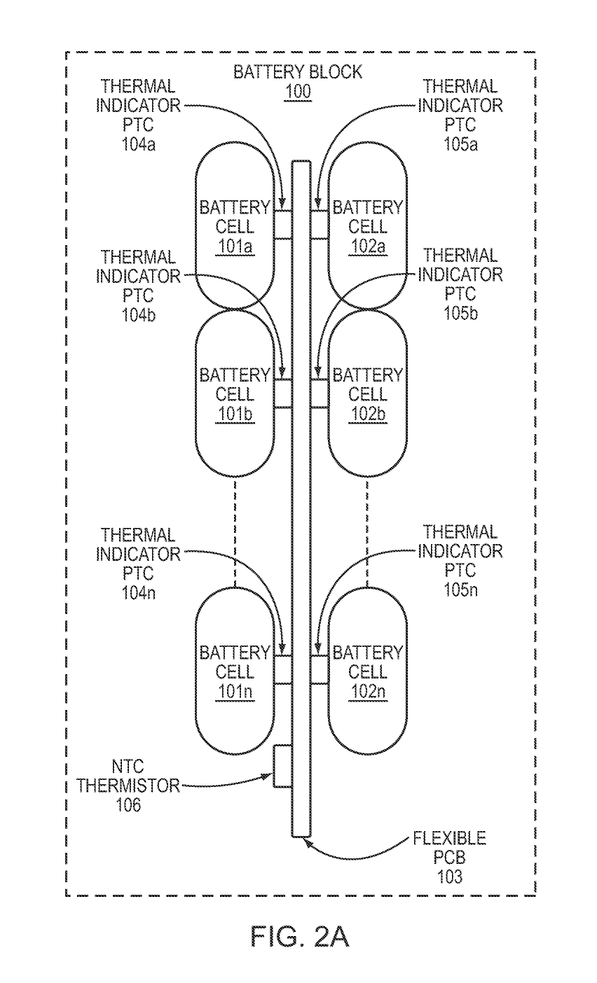

A battery block 100 may include a plurality of battery cells 101a-n, a contactor 110 to connect the cells to the power bus 120, a plurality of PTC devices 104a-n, at least one NTC sensor 106 (e.g., a thermistor), and a thermal bus 107 (e.g., a copper area incorporated in a printed circuit board (PCB)). The PTC devices 104a-n may each be configured to detect a relative temperature at a respective battery cell 101a-n, while the NTC thermistor may measure the average temperature of some or all of the battery cells 101a-n via the thermal bus 107, which is thermally coupled to some or all of the battery cells 101a-n. The battery block 100 may be configured in a number of different architectures and operational modes as described below with reference to FIGS. 2A-E. Battery blocks 170, 175 may be configured in a similar manner.

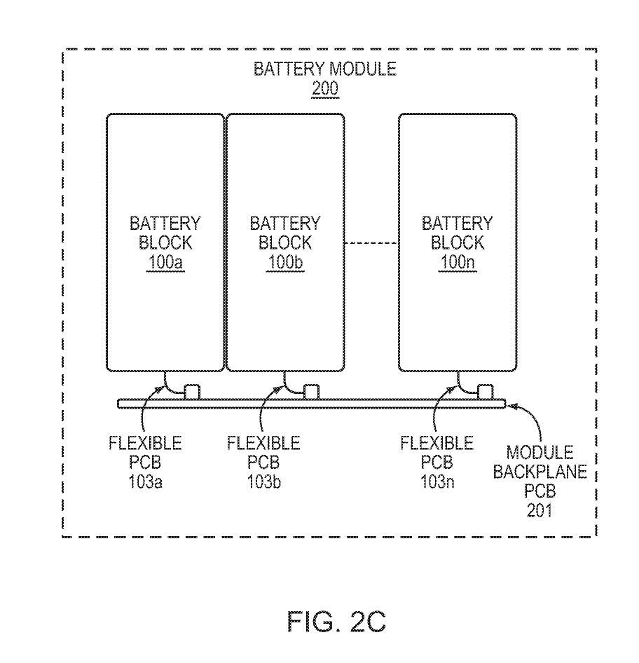

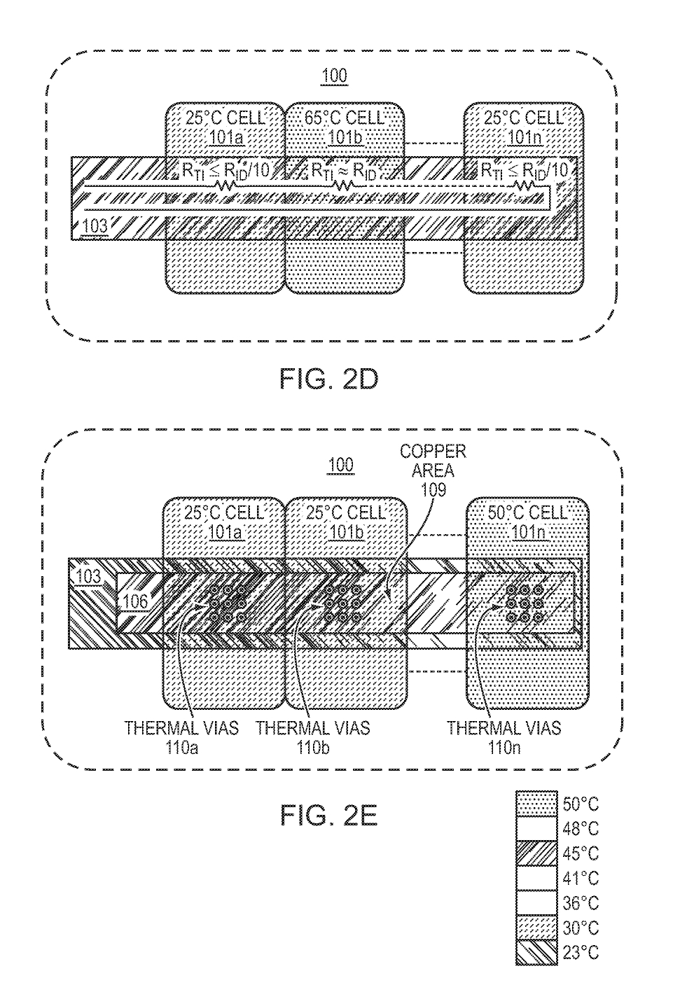

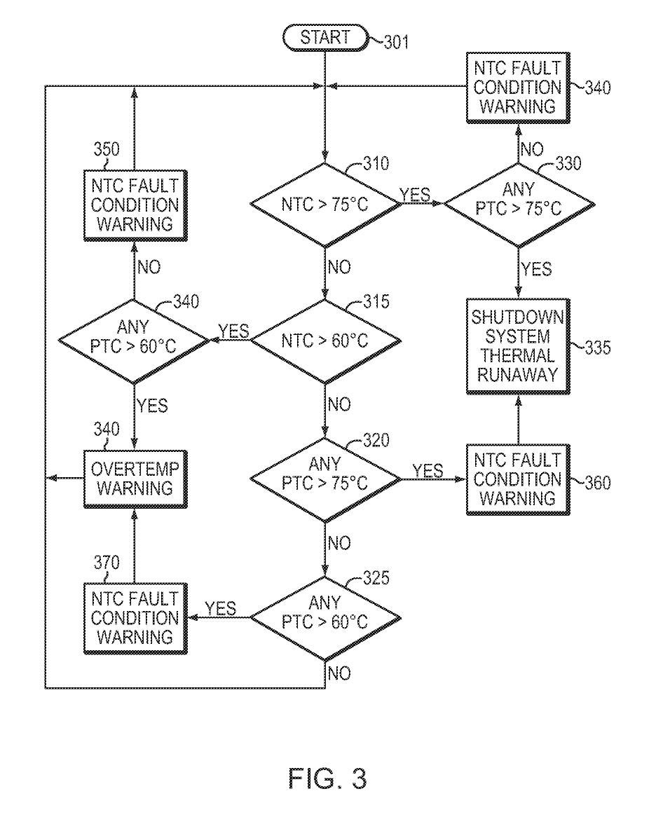

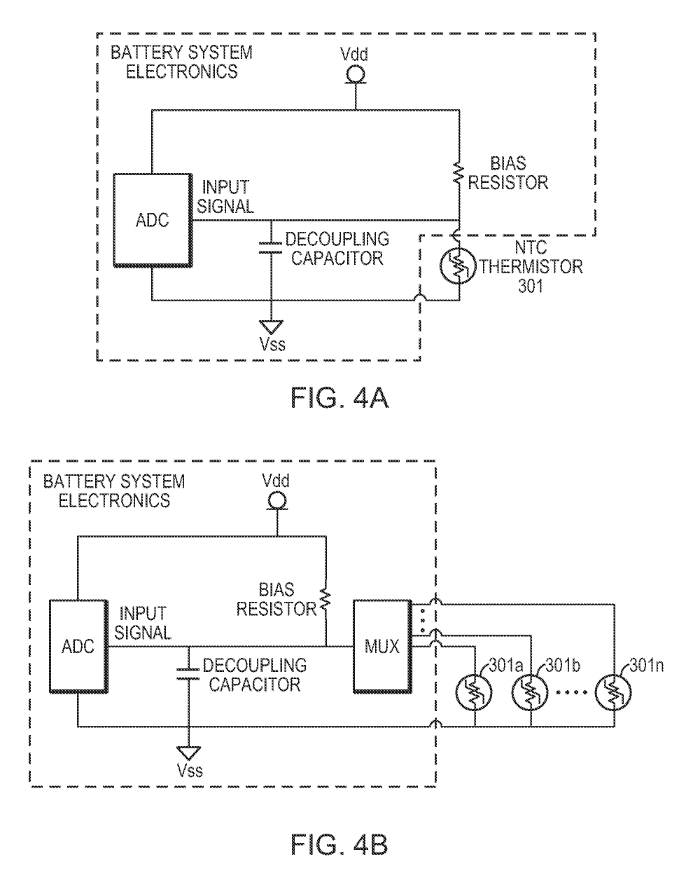

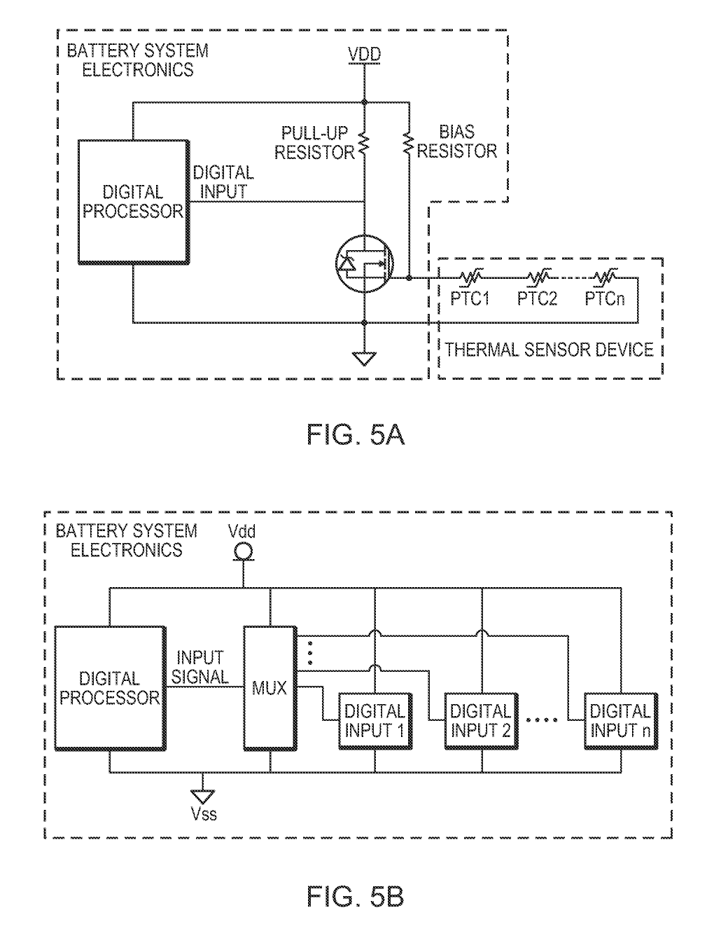

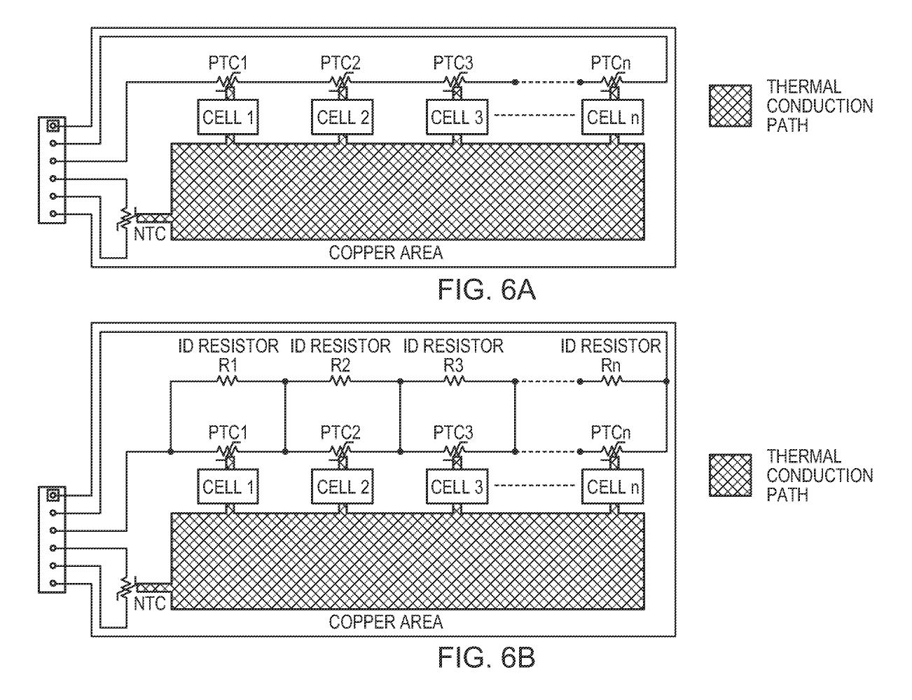

The battery control electronics 160 includes a digital control processor 180, which receives temperature feedback information from each of the battery blocks 100, 170, 175. A PTC multiplexor 186 and an analog to digital converter (ADC) circuit 185 receive the PTC data from each battery block 100, 170, 175 and forward the PTC data to the digital control processor 180. Example PTC multiplexor and ADC circuits are described below with reference to FIGS. 5B and 6B. A NTC multiplexor 187 and ADC circuit 188 receives the NTC data from each battery block 100, 170, 175 and forwards the NTC data to the digital control processor 180. Example NTC multiplexors 187 and ADC circuits are described below with reference to FIG. 4A-B. In further embodiments, the digital control processor 180 may receive additional information as inputs, such as a present measure of current demand on the battery block(s) 100, 170, 175, and combine this information with PTC and NTC temperature feedback to provide a thermal model of the battery block(s) 100, 170, 175. This model may be employed by temperature control logic at the digital control processor 180 for controlling temperature of the battery block(s) 100, 170, 175, such as by disabling one or more battery cells 101a-n, disabling an entire battery block 100, or by enabling or adjusting a cooling fan 190.

In further embodiments, one or more components of the battery control electronics (e.g., the digital control processor 180 and signal modules 185-188) may be incorporated into one or more of the battery blocks 100, 170, 175.

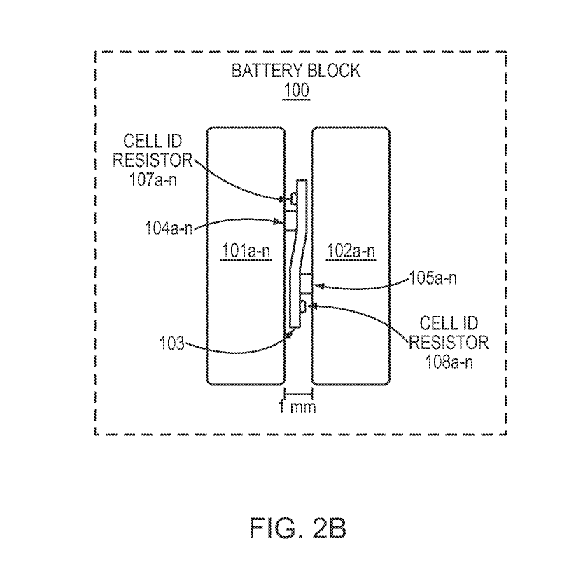

The battery system 150 may operate in the manner described below, with reference in particular to FIG. 3.

FIGS. 2A-E illustrate a battery block 100 in multiple different configurations, each of which may be implemented in the system described above with reference to FIG. 1. As shown in FIG. 2A, a battery block 100 includes a plurality of battery cells 101a-n, 102a-n of a multi-cell battery. Each of the battery cells 101a-n, 102a-n is thermally coupled to a respective positive temperature coefficient (PTC) device 104a-n, 105a-n. Each PTC device 104a-n, 105a-n may be physically coupled to the respective battery cell 101a-n, 102a-n, or may be located within a proximity of the battery cell 101a-n, 102a-n so as to detect the temperature of the battery cell 101a-n, 102a-n.

A printed circuit board (PCB) 103 is configured as a support to which the plurality of battery cells 101a-n, 102a-n, PTC devices 104a-n, 105a-n, or both, may be mounted. Further, a temperature sensor, such as a negative temperature coefficient (NTC) thermistor 106, may also be mounted to the PCB board. The PCB board 103 may be thin and flexible so that it can support a variety of physical multi-cell battery configurations. In some embodiments, the PCB board 103 may include a thermal heat transfer bus, such as a copper layer, as described below. The heat transfer bus may be thermally coupled to the NTC thermistor 106 and the plurality of battery cells 101a-n, 102a-n, so as to conduct an average temperature of the battery cells 101a-n, 102a-n for measurement by the NTC thermistor 106. In alternative embodiments, the PTC devices 104a-n, 105a-n may and NTC thermistor 106 be replaced with any other suitable component or devices for detecting relative temperature or measuring a temperature.

FIG. 2B illustrates portion of a battery block 100 in a further embodiment. Here, the PCB board 103 is flexed between two sets of battery cells 101a-n, 102a-n. By placing components on both sides of the PCB with an offset, the PTC devices 104a-n, 105a-n can fit between two rows of battery cells in a narrow gap (e.g., less than 1 mm). Each PTC device 104a-n, 105a-n may be accompanied by a respective cell ID resistor 107a-n, 108a-n, operation of which is described below.

FIG. 2C illustrates a battery module 200 comprising a number of battery blocks 100a-n. The battery blocks 100a-n are connected to a common backplane PCB 201 via a respective flexible PCB 103a-n. The backplane 201 may further link each of the battery blocks 100a-n to system electronics for controlling the battery blocks 100a-n.

FIGS. 2D and 2E illustrate a battery block 100 in further configurations to demonstrate a response to thermal effects. Operation of the battery blocks 100 in FIGS. 2D and 2E is described in further detail below with reference to FIGS. 6A and 6B.

FIG. 3 is a flow diagram of a process for monitoring and controlling a multi-cell battery of a battery block, such as the battery block 100 in an embodiment described above. The process may be completed by a battery controller, such as the battery control electronics 160 described above with reference to FIG. 1. Following startup 301, the NTC temperature is compared against a threshold of 75 C (310). If the NTC temperature exceeds this threshold, and any of the PTC temperatures exceeds 75 C (330) then the system is shutdown due to a thermal runaway condition (335). If none of the PTC temperatures exceed 75 C, then a NTC fault condition warning is issued (340), and monitoring continues. An NTC fault condition warning may cause the battery controller to take additional operations, such as adjusting power output of one or more of the battery cells, disabling one or more of the battery cells, or controlling an active cooling system such as a fan.

If the NTC temperature exceeds 60 C (but not 75 C) (315), and any of the PTC temperatures exceed 60 C (340), then an overtemperature warning is issued (345). The battery controller may then limit or disable the respective battery cell, or initiate or adjust a battery cooler to prevent excessive heat in the battery block. If none of the PTC devices exceed this threshold, then an NTC fault condition warning is issued (350), and monitoring continues.

If the NTC temperature does not exceed 60 C but any of the PTC temperatures exceed 75 C (320) or 60 C (325), then a corresponding NTC fault condition warning is issued (360, 370). This condition may lead to a system shutdown (335) or an overtemperature warning (345). A NTC fault condition warning may further cause the battery controller to take additional operations, such as adjusting power output of the respective battery cell, disabling the battery cell, or controlling an active cooling system such as a fan.

In alternative embodiments, the process of FIG. 3 may be configured to control a battery block based on different temperature thresholds, or may perform different or additional control operations, such as disabling a single battery cell or a group of battery cells based on respective PTC information, or controlling a battery cooling system. Additional temperature information, such as multiple NTC and PTC thresholds, may be utilized for controlling the battery block.

FIG. 4A is a schematic diagram of a monitor for a NTC thermistor 301, which may be incorporated in the battery system described above with reference to FIG. 1. The output of a NTC thermistor 301 is received as an input to an analog-to-digital converter (ADC) circuit, which converts the temperature-dependent resistance of the NTC thermistor 301 to a digital temperature reading. This temperature reading may then be incorporated into the battery system electronics firmware algorithms to optimize state-of-charge (SOC), state-of-health (SOH) and state-of-life (SOL) estimations as well as providing temperature fault detection capability. Similar ADC devices may also be used in the battery system to measure cell voltages, thereby contributing to such optimization and monitoring.

FIG. 4B is a schematic diagram of a monitor for a plurality of NTC thermistors. The monitor may be comparable to the monitor described above and in FIG. 4A, but further includes a multiplexor for receiving outputs of multiple NTC thermistors 301a-n and forwarding the outputs to the ADC circuit. This approach may be adapted for large battery systems requiring multiple battery blocks with associated temperature sensors, and may reduce cost and system complexity by employing a single monitor module.

FIG. 5A is a schematic diagram of a monitor for a thermal sensor device (e.g., a PTC device comprising several PTC sensors PTC1-PTCN connected in series), which may be incorporated in the battery system described above with reference to FIG. 1. The output of the PTC device is received as an input to a digital processor circuit, which processes the input to detect a temperature condition (e.g., a high temperature fault) at one or more of the PTC sensors. This temperature reading may then be incorporated into the battery system electronics firmware algorithms to optimize state-of-charge (SOC), state-of-health (SOH) and state-of-life (SOL) estimations as well as providing temperature fault detection capability. The battery system may incorporate both an NTC thermistor monitor (FIG. 4A) and the PTC monitor to provide both an average temperature of the battery cells and temperature fault detection for each of the battery cells.

FIG. 5B is a schematic diagram of a monitor for a plurality of PTC devices. The monitor may be comparable to the monitor described above and in FIG. 5A, but further includes a multiplexor for receiving outputs of multiple PTC devices (digital inputs 1-n) and forwarding the outputs to the digital processor circuit. This approach may be adapted for large battery systems requiring multiple battery blocks with associated temperature sensors, and may reduce cost and system complexity by employing a single monitor module.

FIG. 6A is a schematic diagram of a battery block, such as the battery block 100 described above, implementing a thermal conduction path or heat bus. A PCB board provides a support to which the battery cells (Cell 1, Cell 2 . . . . Cell n) and respective PTC devices (PTC1, PTC2 . . . PTCn) may be mounted. Each PTC device may be physically coupled to, or located in close proximity to, the respective battery cell so as to detect the temperature of the battery cell independent of the other battery cells. A copper area, which may be incorporated as a layer at or within the PCB board, provides a thermal heat transfer bus linking the battery cells to the NTC thermistor, thereby enabling the NTC thermistor to obtain an accurate reading of an average temperature of the battery cells.

Under normal conditions, the series impedance of the string of PTC devices is a predetermined value (e.g., less than 100 kΩ). The PTC devices may be adapted such that, if one or more of the cells being monitored reaches a temperature greater than a threshold temperature (e.g., 65° C.) the series impedance will rise above 10MΩ. A battery system receiving the series impedance of the PTC devices may then determine that a temperature fault has occurred at one or more of the battery cells, and can respond with appropriate safety measures, such as disabling one or more of the battery cells, or employing a cooling system. The NTC thermistor and PTC devices further provide a fail-safe mechanism with respect to one another, enabling temperature fault detection and optimization in the event that one of the devices fails.

FIG. 6B is a schematic diagram of a battery block implementing a thermal conduction path in a further embodiment. In some battery systems, it is beneficial to determine exactly which cell is above a temperature threshold. To obtain this information, the PTC devices can be modified by adding ID resistors (R1 . . . Rn) of different values in parallel with each PTC sensor (PTC1 . . . PTCn), such that the fault impedance will be unique for each cell being monitored. The series impedance of the PTC devices can then be determined by connecting to an ADC circuit, and the measured impedance value may indicate a particular cell that has exceeded the temperature threshold.

Further embodiments demonstrating identifying a particular battery cell are shown in FIGS. 2D and 2E. In FIG. 2D, each of the battery cells 101a-n is coupled in parallel with a unique fixed, temperature-independent ID resistor, one for each respective PTC device. ID resistances should be chosen to be at least 10 times larger than the PTC resistance under a temperature threshold (e.h. 25 C). Each ID resistor combined in parallel with the associated PTC device forms a dynamic resistance with a temperature-dependent value R_{TI} ranging from less than R_{ID}/10 (low temperature where resistance is dominated by the PTC device) to the value R_{ID} (high temperature where resistance is dominated by the ID resistance), where R_{ID} is unique for each ID resistor. Battery cells 101a and 101n are operating under a temperature threshold (e.g., 25 C), and so their ID resistors have a relatively small value R_{TI}≦R_{ID}/10. Battery cell 101b is operating at a high temperature (60 C), and so its ID resistor in parallel with PTC device has a value R_{TI}=R_{ID}. As a result, a monitor receiving the output of the PTC device can measure the impedance of the series ladder circuit of PTC devices in parallel with ID resistances to determine that battery 101b is above a temperature threshold. In addition, by measuring the impedance of the series ladder circuit, and assuming only one high temperature battery cell, the resistance of the entire series ladder will approximately correspond to the ID resistance of the cell at high temperature. A battery system may then respond by disabling the identified battery cell 101b or providing other safety measures to the battery block.

Turning again to FIG. 2E, a battery block 100 is configured in a manner similar to the battery block shown in FIG. 2D, with the exception that heat sink pad and thermal vias 110a-n are used to provide thermal coupling between each of the cells 101a-n and the PCB 103. As a result of greater thermal conductivity along copper thermal heat transfer bus 109 at the PCB 103, the battery cells transfer heat with greater efficiency to the NTC thermistor. As a result, the NTC device measures an average temperature that is more representative of the temperature of the battery cells 101a-n, and may detect a condition where one battery cell (e.g., battery cell 101n) is above a temperature threshold. The NTC temperature signal may then connected to the battery system electronics through an analog-to-digital converter (ADC) as shown in FIG. 4A.

A predictive thermal diagnostic algorithm can also be achieved by monitoring both analog signals and comparing to a thermal model of the battery system. Based on the rate of change of the two signals, this algorithm could predict the onset of a thermal fault and reduce the load current before the fault condition is reached. In addition the battery pack current demand and thermal model can be used in conjunction with the thermistor temperature input signal to implement an efficient thermal management system with a feed-forward control loop.

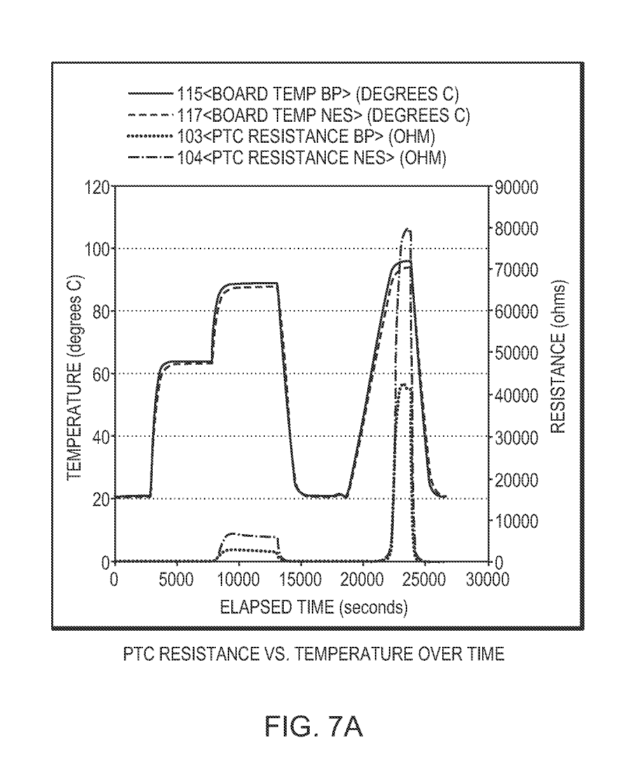

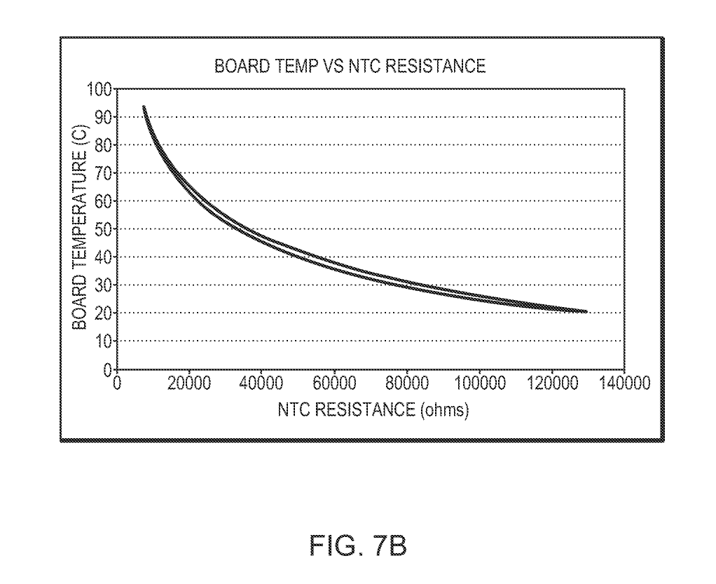

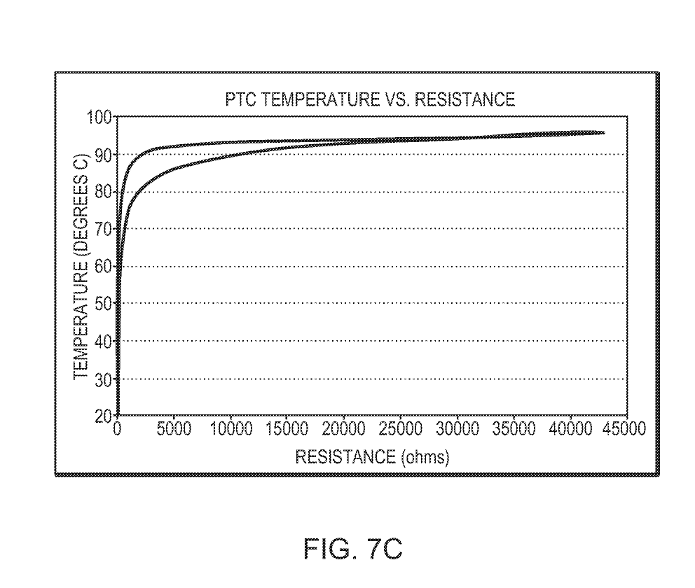

FIG. 7A is a plot of resistance and temperature data of a thermal indicator (PTC device) installed on a thermal sensor printed circuit board in one embodiment. From this plot, it can be seen that the resistance of a PTC device remains a constant low value at most board temperatures. In response to a temperature above a threshold (e.g, 65 C), the resistance value increases substantially in a nonlinear manner. A PTC device may be configured to respond to different temperatures, thereby adapting to a range of temperature thresholds for a battery cell.

FIG. 7B is a plot of negative thermal coefficient (NTC) resistance vs. temperature of a thermistor installed in a thermal printed circuit. From this plot, it can be seen that an NTC thermistor may provide a consistent resistance correlated with a given temperature, thereby providing an accurate temperature measurement.

FIG. 7C is a plot of positive thermal coefficient (PTC) temperature vs. resistance installed in a thermal printed circuit board. As in the plot of FIG. 7A, it can be seen that the resistance of a PTC device retains a minimal value through most temperatures up to a threshold. At and above this threshold, the PTC device resistance increases substantially. As the device cools down again a significant hysteresis effect may occur. The high degree of nonlinearity and hysteresis effect can make accurate temperature measurement challenging when using certain PTC devices without additional information.

While this invention has been particularly shown and described with references to example embodiments thereof, it will be understood by those skilled in the art that various changes in form and details may be made therein without departing from the scope of the invention encompassed by the appended claims.

What is claimed is:

1. A system for monitoring a multi-cell battery, the system comprising:
a plurality of positive-temperature coefficient (PTC) devices, each PTC device configured to detect relative temperature at a respective one of a plurality of cells of a multi-cell battery;
a thermal sensor configured to measure an average temperature among the plurality of cells; and
a control circuit configured to selectively enable and disable a cell of the plurality of cells based on outputs of the plurality of PTC devices and thermal sensor.

2. The system of claim 1, wherein the thermal sensor includes a negative-temperature coefficient (NTC) thermistor.

3. The system of claim 1, wherein the control circuit is configured to selectively enable and disable a subset of the plurality of cells independent of a remainder of the plurality of cells.

4. The system of claim 1, wherein the control circuit is configured to selectively enable and disable the plurality of cells.

5. The system of claim 1, wherein the control circuit is further configured to selectively enable and disable a cell of the plurality of cells based on the outputs of the plurality of PTC devices independent of the output of the thermal sensor.

6. The system of claim 5, wherein the control circuit is further configured to detect a fault at the thermal sensor.

7. The system of claim 1, wherein the control circuit is further configured to selectively enable and disable a cell of the plurality of cells based on the output of the thermal sensor independent of the output of the plurality of PTC devices.

8. The system of claim 7, wherein the control circuit is further configured to detect a fault at the PTC devices.

9. The system of claim 1, wherein the control circuit is further configured to selectively enable a cooling unit based on outputs of the plurality of PTC devices and thermal sensor.

10. The system of claim 1, wherein the cooling unit includes a fan directed at least one of the plurality of cells.

11. The system of claim 1, further comprising a thermal bus coupled to the thermal sensor.

12. The system of claim 11, wherein the thermal bus is incorporated into a printed circuit board (PCB).

13. The system of claim 11, wherein the thermal bus is incorporated into an electrical power bus connecting the plurality of cells.

14. The system of claim 11, wherein the thermal bus is incorporated into an enclosure supporting the plurality of cells.

15. The system of claim 1, further including a monitor circuit configured to determine the temperature status of each of the plurality of cells based on a measured resistance across the plurality of PTC devices.

16. The system of claim 1, wherein the plurality of PTC devices are connected in a series circuit configuration.

17. The system of claim 16, wherein the plurality of PTC devices each include a PTC resistor and an identification resistor connected in parallel, the identification resistor having a unique value among each of the plurality of PTC devices.
